(19) United States
(12) Patent Application Publication
(10) Pub. No.: US 2008/0263275 A1
(43) Pub. Date: Oct. 23, 2008

(54) DATA STORAGE CONTROLLER

(76) Inventor: Alastair Cooper, Hampshire (GB)

Correspondence Address: ZILKA-KOTAB, PC- IBM, P.O. BOX 721120, SAN JOSE, CA, 95172-1120, US

(21) Appl. No.: 11/945,981

(22) Filed: Nov. 27, 2007

(30) Foreign Application Priority Data
Jun. 14, 2005 (GB) 0512043.1
Jun. 6, 2006 (EP) PCT/EP2006/062924

(51) Int. Cl. G06F 12/00

(52) U.S. Cl. 711/114; 711/E12.001

(57) ABSTRACT

A system, method and computer program product for controlling a storage device. The system comprises a monitoring component for monitoring and storing information upon which storage device use can be predicted; a predictor component for predicting storage device use responsive to receipt of the information; and a control component for controlling a power-management-capable device driver to initiate a storage component of the storage device responsive to the predictor component.

### FIELD OF THE INVENTION

The present invention relates to controlling data storage, and more particularly to controlling a spin state of a storage device or devices.

### BACKGROUND OF THE INVENTION

Serial ATA drives (SATA) have not been designed to the same level of reliability or performance as the SCSI (Small Computer Serial Interface) drives currently used by enterprise level storage systems. They were not originally designed or intended for the I/O stress of continuous availability nor for the heat and vibration caused by constant spun-up (rotating at usable speed) state, but rather for the random and inconsistent use characteristics of a personal or home PC. This has led to concerns about the drives' reliability in the always-on environment that is required for typical enterprise-level storage systems (especially those with high-availability requirements).

It would thus be advantageous to improve the reliability of lower-cost ATA drives in enterprise-level storage systems, in a way that would be applicable to any storage controller, but more particularly any storage virtualisation controller, for use with drives having a specification that contains power management features (FATA or SCSI, for example), and which can be extended to permit storage-system-wide power management.

### SUMMARY OF THE INVENTION

The present invention accordingly provides, in a first aspect, a system for controlling a storage device, the system comprising: a monitoring component for monitoring and storing information upon which storage device use can be predicted; a predictor component for predicting storage device use responsive to receipt of the information; and a control component for controlling a power-management-capable device driver to (partially or fully) initiate a storage component of the storage device responsive to the predictor component.

The system preferably comprises a virtualization layer for addressing virtualized storage components; wherein the virtualization layer is operable to manage its storage capacity responsive to information received from the monitoring component and the predictor component.

The system preferably comprises a RAID controller.

Preferably, the storage component is maintained in a selected minimal power configuration corresponding to predicted demand.

The storage component may be an ATA or a SATA drive. The storage component might also be a FATA or a SCSI drive.

Initiating the storage component may include spinning up the storage component e.g., from a standby or low power mode, starting the storage component from a powered down state, etc.

In one embodiment, there is provided an arrangement of system comprising a host computer system, a communications component and the system of the first aspect.

In another embodiment, there is provided a method and computer program product for operating a system for controlling a storage device. The method comprises monitoring and storing information upon which storage device use can be predicted; predicting storage device use responsive to receipt of the information; and controlling a power-management-capable device driver to initiate, e.g., spin up, a storage component of the storage device responsive to the predicting.

The method preferably further comprises addressing virtualized storage components for managing a storage capacity in response to information received about the monitoring and the predicting.

The method preferably further comprises the step of controlling a RAID array.

Preferably, the storage component is maintained in a selected minimal power configuration corresponding to predicted demand.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 shows in schematic form one arrangement of apparatus in which the present invention may be embodied;

FIG. 2 shows in flowchart form one logic arrangement in which a method of operation according to a preferred embodiment of the present invention may foe implemented; and

FIG. 3 shows in schematic form a preferred arrangement of apparatus comprising a storage virtualisation engine, and in which the present invention may be embodied.

### DETAILED DESCRIPTION OF THE PREFERRED EMBODIMENTS

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, ail terms are to be given their broadest possible interpretation including meanings implied from the specification as well as meanings understood by those skilled in the art and/or as defined in dictionaries, treatises, etc.

The following description describes systems and methods for controlling data storage, such as controlling a spin state (e.g., the physical readiness state of the storage medium, such as a disk) of a storage device or devices.

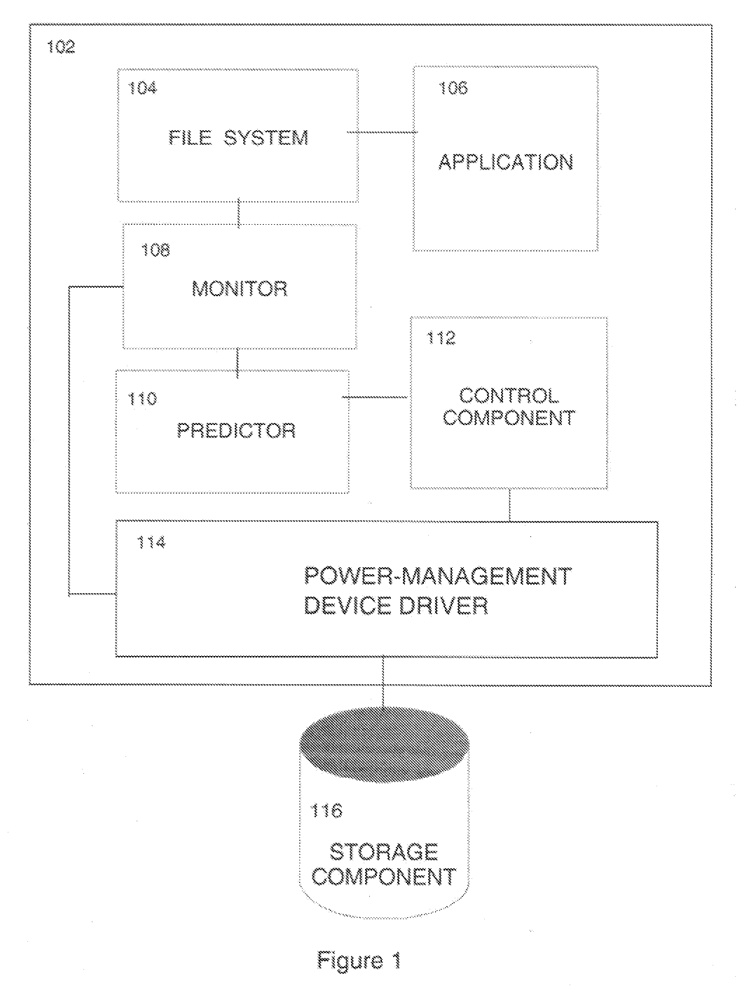

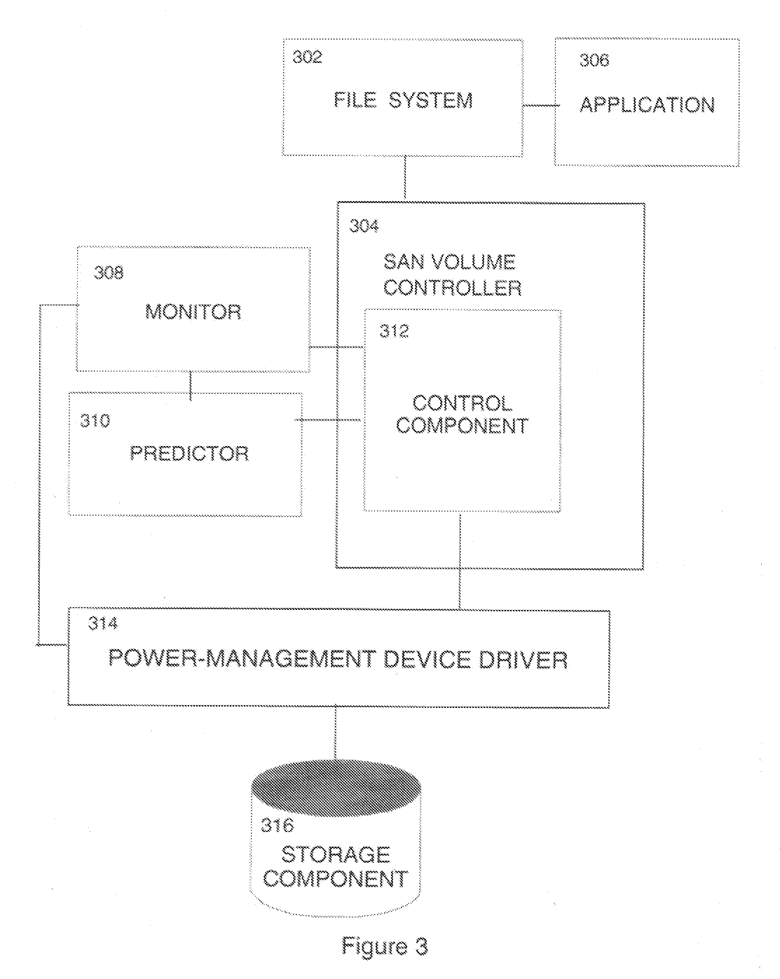

In one general embodiment, described generally with reference to FIGS. 1 and 3, an apparatus for controlling a storage device comprises a monitoring component 108/303 for monitoring and storing information upon which storage device use can be predicted; a predictor component 110/310 for predicting storage device use responsive to receipt of the information; and a control component 112/312 for controlling a power-management-capable device driver to initiate, e.g., spin up, a storage component of the storage device responsive to the predictor component.

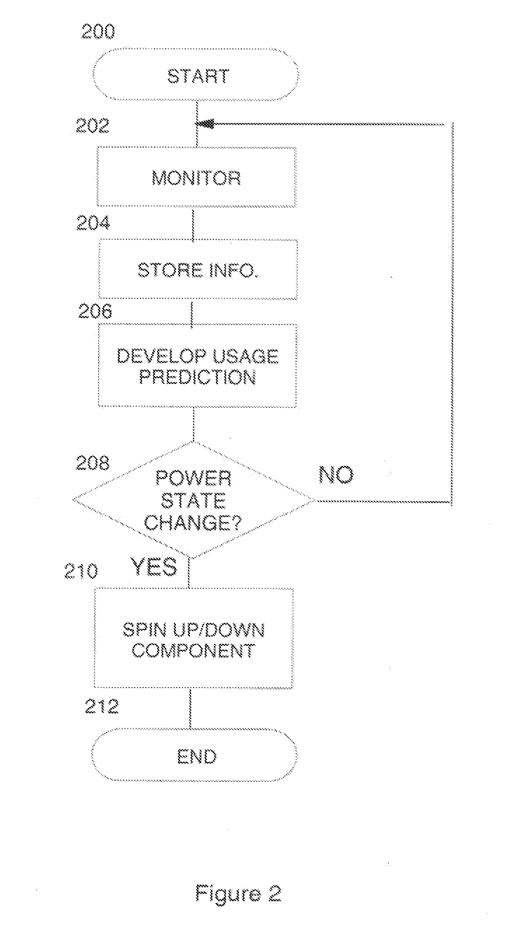

In another general embodiment, described generally with reference to FIG. 2, there is provided a method 200 for operating an apparatus for controlling a storage device. The method comprises monitoring and storing, by a monitoring component, information upon which storage device use can be predicted; predicting, by a predictor component, storage device use responsive to receipt of the information; and controlling, by a control component, a power-management-capable device driver to initiate, e.g., spin up, a storage component of the storage device responsive to the predictor component.

In yet another general embodiment, described generally with reference to FIG. 2, a computer program product comprises a computer useable medium having a computer readable program, wherein the computer readable program when executed on a computer causes the computer to: monitor and store information upon which storage device use can be predicted; predict storage device use responsive to receipt of the information; and control a power-management-capable device driver to initiate, e.g., spin up, a storage component of the storage device responsive to the predicting.

To further the understanding of an illustrative embodiment of the present invention, it is observed that when a storage device is virtualized but under-utilized, large numbers of storage components, e.g., individual drives or arrays of drives, may not be allocated as extents, or extents that are allocated may not be used regularly. Similarly, even if the storage pool is fully allocated, certain parts of it may not be required from an application point of view at any particular time.

There are at least two possibilities for power-management of the nodes, e.g., storage components. The first possibility may be characterized as “passive”, in that the virtualization controller is transparent to the file-system power commands. They are routed directly to the appropriate RAID controller for the LBA, which then utilizes the commands to keep activated components spun-up (bearing in mind that a RAID component in a spun-down, but otherwise “good”, state is still “visible” to the virtualization device). In this case the virtualization device is fulfilling a simple management function by passing application requests to the appropriate storage controller.

The second possibility may be described as “active”. In this case, the virtualization device is using the resource request commands directly to manage servers that have extents or storage resources which are (for an extended, but perhaps temporary, period) not required. In other words, it is sending block activation commands to the appropriate RAID manager (e.g. “I have extents A B C, LBAs U→V of A, W→X of R and Y→Z of C are active, and must be powered on”) which then interprets which components are required to be activated and thereby manages access to its components.

In a first example of such a system in operation, a database program opens and immediately requests access to one particular resource through the file system. The controller calculates which devices are required to serve this request, and makes these active.

In a second example, several storage servers (with multiple arrays) are virtualized in a dynamically allocated storage tank. The servers may control storage components that are not allocated as extents, but are physically available and can be individually managed for power-down requirements. Those that are partially utilized can “rest” their unused components while allowing access to the required areas.

Turning now to FIG. 1, there is shown in schematic form one arrangement of an apparatus in which the present invention may be embodied.

The explanation which follows illustrates a simplified arrangement provided within a control apparatus 102, for example, a storage virtualisation apparatus. Control apparatus 102 is operable in communication with storage component 116, which may be an ATA, SATA, FATA, SCSI, etc. drive for example. The control apparatus 102 comprises an interface to a file system 104 and to an application 106. Clearly, in typical implementations, there may be a plurality of applications and file systems, including “flat” file systems and database systems, for example. Application 106 makes requests of the file system 104 to operate on files, and these requests are monitored by a monitor component 108, which is arranged to communicate with power management device driver 114. Again, in typical implementations, there will be a plurality of device drivers in any system, but for simplicity, only one is shown here. Information relating to power states of storage component 116 is communicated from device driver 114 to monitor component 108, which may typically store the information for use by predictor 110 or communicate the information immediately to predictor 110. The output of predictor 110 passes to control component 112, which is arranged to pass control requests to device driver 114 for actions to be taken by storage component 116. Preferably, the storage component 116 is maintained in a selected minimal power configuration corresponding to predicted demand.

In a preferred embodiment, a logic arrangement implements a sequence of steps or operations to control a storage device, preferably a storage virtualisation controller device. The steps embodied in the logic arrangement monitor and store, in a monitoring step, information upon which storage device use can be predicted. A predictor component uses the information to predict storage device use responsive to the monitor information. A control step then performs controlling actions with respect to a power-management-capable device driver to initiate and de-initiate a storage component of the storage device responsive to the prediction step. Such initiate function, as used herein, may include spin up of the storage component from a partially or fully powered down state or standby mode, initialization from a fully powered down state, etc.

One particularly preferred embodiment of the present invention uses a storage virtualization controller in conjunction with a RAID storage controller that can power-manage arrays, and places a new application interface in the device driver. This allows information from the application to be used to tell the file system the areas of data that it is likely to access in the immediate future. This information can then be translated into a power management request to the controller to activate the storage components holding the requested resources, until the application relinquishes its interest in them with a termination instruction. In addition, the controller can assign “fringe” activation to components holding neighboring resources, for example, LBAs, that surround the active segment.

Turning now to FIG. 2, there is thus shown in flowchart form one logic arrangement in which the present invention may be embodied. The processing commences at START step 200, and at steps 202 and 204, information is respectively monitored and stored for use in predicting storage device usage. At step 206, a usage prediction is developed. If no power state change is required at this point, as shown at the output of test step 208, the process returns to step 202 and continues. If a power state change is required at test step 208, at step 210, a component is spun up or down accordingly, and at step 212 the process completes.

Additionally, virtualized storage components may be addressed by a virtualization layer, where the virtualization layer is operable to manage its storage capacity responsive to information received from the monitoring component and the predictor component. A RAID or other array may be controlled.

In FIG. 3 is shown a preferred embodiment of the present invention, which may be implemented in hardware devices, in software components, or in a combination of hardware and software. Central to the embodiment is a virtualization layer for addressing virtualized storage components, where the virtualization layer is operable to manage its storage capacity responsive to information received from the monitoring component and the predictor component. In the embodiment shown, the virtualization layer includes a Storage Area Network (SAN) Volume Controller 302, which is capable of addressing and controlling virtualized storage components on behalf of a file system 304 cooperable with an application 306, the file system 304 and the application 306 being typically embodied in one or more host computer systems. The SAN Volume Controller 302 is in communication with the monitor component 308 and predictor component 310, typically by means of an additional control component 312 over and above the conventional SAN Volume Controller components. Control component 312, using the information from the monitor component 308 and predictor component 310, is arranged to actively manage the storage capacity of one or more storage components 316 by manipulating the power management functions of power-management capable device driver 316.

It will be clear from the foregoing to one skilled in the art that the preferred embodiments of the present invention lead to a situation in which less power is consumed by storage activities and less stress is exerted upon the physical components of the storage devices, which thus benefit from improved reliability and enhanced service life.

It will also foe clear to one skilled in the art that the method of the present invention may suitably be embodied in a logic apparatus comprising logic to perform various steps of the methodology presented herein, and that such logic may comprise hardware components or firmware components.

If will be equally clear to one skilled in the art that the logic arrangement in various approaches may suitably be embodied in a logic apparatus comprising logic to perform various steps of the method, and that such logic may comprise components such as logic gates in, for example, a programmable logic array. Such a logic arrangement may further be embodied in enabling means or components for temporarily or permanently establishing logical structures in such an array using, for example, a virtual hardware descriptor language, which may foe stored using fixed or transmittable carrier media.

It will be appreciated that the methodology described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

Embodiments of the present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

Communications components such as input/output or I/O devices (including but not limited to keyboards, displays, pointing devices, etc.) can be coupled to the system either directly or through intervening I/O controllers.

Communications components such as buses, interfaces, network adapters, etc. may also be coupled to the system to enable the data processing system, e.g., host, to become coupled to other data processing systems or remote printers or storage devices through intervening private or public networks. Modems, cable modem and Ethernet cards are just a few of the currently available types of network adapters.

It will be further appreciated that embodiments of the present invention may be provided in the form of a service deployed on behalf of a customer to offer service on demand.

It will also be appreciated that various further modifications to the preferred embodiment described above will be apparent to a person of ordinary skill in the art.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A system for controlling a storage device, the system comprising:
a monitoring component for monitoring and storing information upon which storage device use can be predicted;
a predictor component for predicting storage device use responsive to receipt of the information; and
a control component for controlling a power-management-capable device driver to initiate a storage component of the storage device responsive to the predictor component.

2. The system of claim 1, comprising a virtualization layer for addressing virtualized storage components; wherein the virtualization layer is operable to manage its storage capacity responsive to information received from the monitoring component and the predictor component.

3. The system of claim 2, further comprising a RAID controller.

4. The system of claim 1, further comprising a RAID controller.

5. The system of claim 1, wherein the storage component is maintained in a selected minimal power configuration corresponding to predicted demand.

6. The system of claim 1, wherein the storage component is an ATA or a SATA drive.

7. The system of claim 1, wherein the storage component is a FATA or a SCSI drive.

8. The system of claim 1, wherein initiating the storage component includes spinning up the storage component.

9. The system of claim 1, further comprising a host computer system and a communications component.

10. A method for operating a system for controlling a storage device, the method comprising:
monitoring and storing information upon which storage device use can be predicted;
predicting storage device use responsive to receipt of the information; and
controlling a power-management-capable device driver to initiate a storage component of the storage device responsive to the predicting.

11. The method of claim 10, further comprising addressing virtualized storage components for managing a storage capacity in response to information received about the monitoring and the predicting.

12. The method of claim 10, further comprising addressing virtualized storage components by a virtualization layer; wherein the virtualization layer is operable to manage its storage capacity responsive to information received about the monitoring and the predicting.

13. The method of claim 10, further comprising controlling a RAID array.

14. The method of claim 10, wherein the storage component is maintained in a selected minimal power configuration corresponding to predicted demand.

15. The method of claim 10, wherein initiating the storage component includes spinning up the storage component.

16. The method of claim 10, wherein the storage component is an ATA or a SATA drive.

17. The method of claim 10, wherein the storage component is a FATA or a SCSI drive.

18. A computer program product comprising a computer useable medium having a computer readable program, wherein the computer readable program when executed on a computer causes the computer to:
monitor and store information upon which storage device use can be predicted;
predict storage device use responsive to receipt of the information; and
control a power-management-capable device driver to initiate a storage component of the storage device responsive to the predicting.

19. The computer program product of claim 18, wherein the computer readable program when executed on a computer causes the computer to address virtualized storage components for managing a storage capacity in response to information received from the monitoring component and the predictor component.

20. The computer program product of claim 18, wherein the computer readable program when executed on a computer causes the computer to control a RAID array.

21. The computer program product of claim 18, wherein the computer readable program when executed on a computer causes the computer to maintain the storage component in a selected minimal power configuration corresponding to predicted demand.

22. The computer program product of claim 18, wherein initiating the storage component includes spinning up the storage component.

23. The computer program product of claim 18, wherein the storage component is an ATA or a SATA drive.

24. The computer program product of claim 18, wherein the storage component is a FATA or a SCSI drive.
